(19) United States
(12) Patent Application Publication
(10) Pub. No.: US 2023/0373775 A1
(43) Pub. Date: Nov. 23, 2023

(54) REMOTE BEVERAGE SELECTION WITH A BEVERAGE DISPENSER

(71) Applicant: THE COCA-COLA COMPANY, Atlanta, GA (US)

(72) Inventors: Habib MOUKALLED, Atlanta, GA (US); Jason HEJNA, Atlanta, GA (US)

(21) Appl. No.: 18/030,872

(22) PCT Filed: Oct. 18, 2021
(86) PCT No.: PCT/US2021/055418

§ 371 Date: Apr. 7, 2023

Related U.S. Application Data
(60) Provisional application No. 63/092,771, filed on Oct. 16, 2020.

(51) Int. Cl. B67D 1/08

(52) U.S. Cl. CPC B67D 1/0888; B67D 2210/00089

(57) ABSTRACT

A beverage order fulfillment system allows for beverage fulfillment from a mobile device without requiring a custom software application on the mobile device but uses a private intranet connection to control beverage dispenser operations instead. The mobile device incorporates web browser software, allowing the mobile device to initiate secure communications with a beverage dispenser by scanning an embedded code. With secured communications that avoid Internet or external network connections, a mobile device links directly to a beverage dispenser computer that serves a webpage to the mobile device. A remote rendering of the webpage on the mobile device enables beverage selection data to be transmitted back to the computer that controls valve operation at the dispenser.

### CROSS-REFERENCE TO RELATED APPLICATIONS

This application claims priority to and incorporates by reference U.S. Provisional Patent Application Ser. No. 63/092,771 filed on Oct. 16, 2020, and entitled Remote Beverage Selection with a Beverage Dispenser.

### BACKGROUND

Traditional post-mix beverage dispensing systems generally mix streams of syrup, concentrate, sweetener, bonus flavors, other types of flavorings, and/or other ingredients with water or other types of diluents by flowing the syrup stream down the center of the nozzle with the water stream flowing around the outside. The syrup stream is directed downward with the water stream such that the streams mix as they fall into a consumer's cup. There is a desire for a beverage dispensing system as a whole to provide as many different types and flavors of beverages as may be possible in a footprint that may be as small as possible. Recent improvements in beverage dispensing technology have focused on the use of micro-ingredients. With micro-ingredients, the traditional beverage bases may be separated into their constituent parts at much higher dilution or reconstitution ratios.

This technology is enabled via cartridges containing the highly concentrated micro-ingredients. The micro-ingredients are mixed with sweeteners and still or sparkling water using precise metering and dosing technologies and dispensed through a nozzle that promotes in-air mixing so as to prevent carry-over. The technology includes a user input for a user to select a desired beverage, customize the beverage if desired, and pour the beverage at the dispenser. These beverages are made from precise recipes to ensure a great tasting beverage regardless of the customization.

Post-mix beverage dispensing systems using micro-ingredients greatly increase a number of beverage options available at a given dispenser. For example, a personalized interaction with the beverage dispenser may take place as described in U.S. 2015/0082243, filed Sep. 15, 2014, entitled “Product Categorization User Interface for a Dispensing Device”, hereby incorporated by reference in its entirety.

Because a number of users may establish a line or sequence of users (i.e., a queue) awaiting their turn to interact with a beverage dispenser, a queuing problem may come about whereby it is difficult to determine which consumer is addressing the beverage dispenser at a given time and wishes to establish an interaction with the beverage dispenser. The queueing problem is particularly pronounced when the handshake between the dispenser and the consumer's mobile computing device is performed via wireless communication technologies whose range may encompass multiple consumer mobile computing devices. The queuing problem may be further exacerbated when there are multiple beverage dispensers within wireless communication range.

Prior solutions to the queueing problem have focused on deterministic methods of ascertaining which consumer is addressing a particular beverage dispenser at a given time. For example, a consumer may use their mobile computing device to scan an identifier of the beverage dispenser upon addressing the beverage dispenser, as described in U.S. 2015/0039776, filed Feb. 5, 2015, entitled “Facilitating Individualized User Interaction with an Electronic Device,” hereby incorporated by reference in its entirety. Similarly, for a wireless handshake between the beverage dispenser and the consumer's mobile computing device, a range of a wireless beacon that transmits the identifier of the beverage dispenser is limited (e.g., within 1-12 inches of the beverage dispenser) to restrict the possibility of multiple mobile computing devices in the queue or adjacent queues from receiving the signal, as described in U.S. 2018/0288594, filed Sep. 27, 2016, entitled “Dispenser Connectivity”, hereby incorporated by reference in its entirety.

Another development in beverage fulfillment has allowed consumers to use personal computer device applications (i.e., “mobile apps”) to interact with beverage dispensers. One example implementation of beverage dispensers controlled by mobile apps is discussed in detail in commonly owned international patent application PCT/US2019/067875 filed on Dec. 20, 2019, and incorporated by reference herein. As discussed therein, upon a mobile application installed on a consumer's mobile device reporting to a server that a first dispenser identifier, such as a scanned QR code, has been received from an area, the server may supply data regarding available beverages. For example, the server may supply the consumer's profile to all the beverage dispensers within a particular outlet or all beverage dispensers within a predetermined distance of the consumer's mobile device. In this non-limiting optional embodiment, the beverage dispensers each maintain a database of regional profiles—profiles of consumers within a given region (e.g., outlet or predetermined distance). Likewise, upon the mobile application no longer receiving the first dispenser identifier within a threshold time period or otherwise leaving the region, the consumer's profile is removed from a database of regional profiles.

Even with so many developments in beverage fulfillment processes using mobile devices, consumers remain hindered by technical hurdles that require modifications to current beverage systems. Today's customer base for beverages utilizes self-serve beverage dispensers at multiple establishments, in diverse locations, and often “on-the-fly,” with impulse purchase decisions occurring in real time. Accordingly, some customers may not be inclined to download necessary software and mobile apps, especially if each vending location requires a particular piece of software. A need continues to exist, therefore, in the field of beverage fulfillment for an easier system to use self-serve beverage dispensers with maximum flexibility for the consumer.

### SUMMARY

In a first embodiment, a system for controlling a beverage dispenser to deliver a beverage from a nozzle includes a computer with memory connected to the beverage dispenser. A wireless access point is connected to the beverage dispenser and configured by the computer. A beverage selection webpage is hosted by the computer for wireless transmission within a range of the access point wherein the computer is configured to receive beverage selection data from a remote rendering of the beverage selection website. Within the beverage dispenser, a valve assembly includes an actuator in communication with the computer to configure a valve assembly actuator in an open position or a closed position, wherein the computer transmits control data to the actuator according to the beverage selection data. Conversely, in the open position, the valve assembly actuator is operable to dispense a beverage fluid from a nozzle valve assembly.

In another embodiment, a computer implemented method for controlling a beverage dispenser delivering a beverage to a nozzle starts by hosting a beverage selection webpage in computerized memory connected to a computer installed in the beverage dispenser. The computer also establishes an access point to the webpage with the computer. The computer receives beverage selection data corresponding to the webpage at the access point and transmits the beverage selection data to the computer. By transmitting control data, configured according to the beverage selection data, to an actuator, the actuator is instructed to open and close a valve that distributes the beverage to the nozzle.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 is a PRIOR ART illustration of a beverage dispensing system controlled on a network by remote computers as set forth in the background of this disclosure.

FIG. 2 is a PRIOR ART block diagram of an assembly of valves directing beverage ingredients to a nozzle in a beverage dispenser described herein.

FIG. 3 is a system schematic of a beverage dispenser connected over numerous kinds of networks to remote computers and mobile devices as described herein.

FIG. 4 is a system schematic of a beverage dispenser connected over numerous kinds of networks to remote computers and mobile devices as described herein.

FIG. 5A is a front plan view of a graphical user interface of a beverage dispenser and a remote rendering of the same kinds of selections on a mobile device as described herein.

FIG. 5B is a front plan view of a graphical user interface of a beverage dispenser and a remote rendering of the same kinds of selections on a mobile device as described herein.

FIG. 5C is a flow chart diagram of a beverage selection operation described in the embodiments of this disclosure.

FIG. 5D is a flow chart diagram of a beverage selection operation described in the embodiments of this disclosure.

FIG. 6 is a plan view of a beverage dispenser outfitted with a single board computer, an access point for serving a web page stored in the computer, and at least one transceiver for communicating with valves and valve actuators as described herein.

FIG. 7 is a plan view of a beverage dispenser outfitted with a single board computer, an access point for serving a web page stored in the computer, and at least one signal connector for communicating with valves and valve actuators as described herein.

FIG. 8 illustrates an exemplary graphical user interface screen on a mobile device and steps in communicating with a beverage dispenser according to various embodiments of the disclosure.

FIG. 9 is an illustration of a state machine for an exemplary beverage dispenser system suitable for implementing the several embodiments of the disclosure.

FIG. 10 is an illustration of a data communications scheme that avoids external networks and allows for a direct connection between a beverage dispenser and a mobile device suitable for implementing the several embodiments of the disclosure.

FIG. 11 is an illustration of a data communications scheme that utilizes in-house establishment communications networks and allows for a communications connection between a beverage dispenser and a mobile device suitable for implementing the several embodiments of the disclosure.

FIG. 12 is an example of computer hardware environment that may be used to implement embodiments of this disclosure.

FIG. 13 illustrates an exemplary block diagram of a control architecture for a beverage dispenser suitable for implementing the several embodiments of the disclosure.

### DETAILED DESCRIPTION

It should be understood at the outset that although illustrative implementations of one or more embodiments are illustrated below, the disclosed systems and methods may be implemented using any number of techniques, whether currently known or in existence. The disclosure should in no way be limited to the illustrative implementations, drawings, and techniques illustrated below, but may be modified within the scope of the appended claims along with their full scope of equivalents. Use of the phrase “and/or” indicates that any one or any combination of a list of options can be used. For example, “A”, “B”, and/or “C” means “A”, or “B”, or “C”, or “A and B”, or “A and C”, “B and C” or “A and B and C”.

A beverage dispenser 104 may have one or more wireless communication devices associated with the dispenser, giving the beverage dispenser added functionality for multiple embodiments of this disclosure. For example, each may be configured to broadcast one or more dispenser identifiers of the beverage dispenser to remote devices if such technology is helpful to validate secure communications with customer devices, servers, or other computers in a retail establishment. For example, a dispenser identifier may be an identifier common to a plurality of beverage dispensers or all compatible beverage dispensers. Another dispenser identifier may uniquely identify a particular beverage dispenser.

In some implementations, specialized configurations are possible when beverage dispensers are “smart dispensers” with multiple communications capabilities. For example, the beverage dispenser 104 may include a plurality of wireless communication devices 102 that each broadcast a dispenser identifier and connect to various remote computers at a different communication range. For example, the first wireless communication device may be a WiFi modem 112 with a communication range of around 100-300 feet. A second wireless communication device may broadcast a second dispenser identifier at a second range from the beverage dispenser. For example, the second wireless communication device may be a Bluetooth® beacon with a communication range of around 10-20 feet.

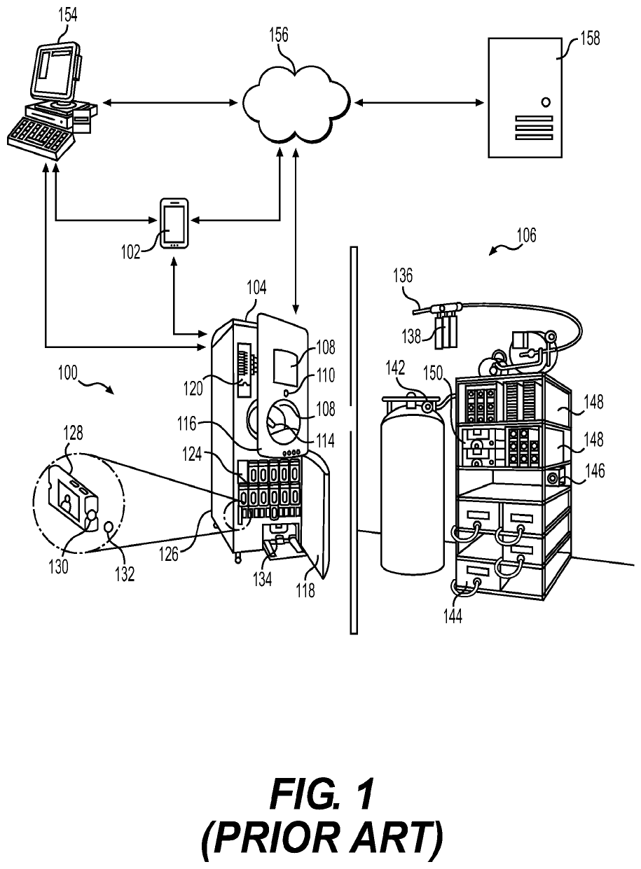

FIG. 1 illustrates an exemplary beverage dispenser system 100 suitable for implementing the several embodiments of the disclosure. As shown, the beverage dispenser system 100 is configured as a cooled beverage dispenser. Other configurations of beverage dispensers are contemplated by this disclosure such as a drop-in ice-cooled beverage dispenser, a countertop electric beverage dispenser, a remote recirculation beverage dispenser, or any other beverage dispenser configuration.

The beverage dispenser system 100 includes a front room beverage dispenser 104 and a back room system 106. The beverage dispenser 104 includes a user interface 108, such as a touchscreen display, to facilitate selection of the beverage to be dispensed. The user interface 108 may employ various screens to facilitate user interactions on the beverage dispenser 104 and/or receive a user profile through interaction with a user's mobile device 102, such as described in commonly owned U.S. patent application Ser. No. 14/485,826, entitled “Product Categorization User Interface for a Dispensing Device,” which is herein incorporated by reference in its entirety.

Upon receiving a beverage selection via the user interface 108, a pour button 110 may be activated to dispense the selected beverage from the beverage dispenser 104 via a nozzle 114. For example, the pour button 110 may be an electromechanical button, capacitive touch button, or other button selectable by a user to activate the beverage dispenser 104 to dispense a beverage. While shown as a button, the pour button 110 may alternatively be implemented as a lever or other mechanism for activating the beverage dispenser 104 to dispense a beverage. As shown in FIG. 1, the pour button 110 is separate from the user interface 108. In some implementations, the pour button 110 may be implemented as a selectable icon in the user interface 108.

In some implementations, the beverage dispenser may also include an ice lever 114. Upon being activated, the ice lever 114 may cause the beverage dispenser 104 to dispense ice through an ice chute (not shown). For beverage dispensers that do not have an ice bin, such as counter-electric or remote recirculation beverage dispensers, the ice lever 114 may be omitted.

The beverage dispenser 104 may be secured via a primary door 116 and an ingredient door 118. The primary door 116 and the ingredient door 118 may be secured via one or more locks. In some implementations, the locks are a lock and key. In some implementations, the lock on the ingredient door 118 may be opened via an RFID reader (not shown) reading an authorize ingredient package 128. The primary door 116 may secure electronic components of the beverage dispenser 104 including one or more controllers 120. The ingredient door 118 may secure an ingredient compartment that houses an ingredient matrix 124.

The ingredient matrix 124 includes a plurality of slots 126 for receiving ingredient packages 128. In various implementations, the ingredient packages 128 may be micro-ingredient cartridges. The micro-ingredient cartridges may be single cartridges or double cartridges, such as described in commonly owned U.S. patent application Ser. No. 14/209,684, entitled “Beverage Dispenser Container and Carton,” and U.S. patent application Ser. No. 12/494,427, entitled “Container Filling Systems and Methods,” which are both herein incorporated by reference in their entirety. As shown in FIG. 1, there are three drawers of ingredients in the ingredient matrix 124. One or more of the drawers may slide back and forth along a rail so as to periodically agitate the ingredients housed on the drawer. Other configurations of the ingredient matrix 124 are possible, such as via one or more static and/or agitated ingredient towers.

Each ingredient package 128 may comprise an RFID tag, a fitting 130, and a fitting seal 132. The fitting seal 132 may be removed prior to installation into the beverage dispenser 104. Upon installation, the fitment 130 may engage with and provide a fluidic communication between a probe (not shown) in the slot 126 and the ingredients contained in the ingredient package 128. The ingredient matrix 124 may also contain one or more large volume micro-ingredient packages 134, such as for one or more micro-ingredient sweetener sources.

The beverage dispenser 104 may also include a carbonator (not shown) for receiving water and carbon dioxide to produce carbonated water. The beverage dispenser 104 may also include one or more heat exchangers (not shown), such as a cold plate, for cooling one or more of the beverage ingredients contained in or received by the beverage dispenser 1004. In some implementations, one or more of the micro-ingredients dispensed via the nozzle 112 are not cooled via the heat exchanger or are otherwise maintained at an ambient temperature. Macro-ingredients dispensed via the nozzle 112 are typically cooled via the heat exchanger prior to being dispensed.

The back room system 106 is typically located in a back room remote from the front room system 102, such as a storage area in a merchant location. The back room system 106 includes a water source 136 such as a municipal water supply that provides a pressurized source of plain water. The water received via the water source 136 may be filtered or otherwise treated by a water treatment system 138. The treated water may optionally be pressurized to a desired pressure with a water booster 140 and supplied to the beverage dispenser. A carbon dioxide source 142 may supply carbon dioxide to the beverage dispenser 104.

One or more macro-ingredient sources 144 may be located in the back room. The macro-ingredient from each macro-ingredient source 144 may be supplied to the beverage dispenser 104 via a pump 146. The pump 146 may be a controlled gear pump, diaphragm pump, BIB pump, or any other suitable pump for supplying macro-ingredients to the beverage dispenser 104. The back room system 106 may also include a rack with one or more storage locations 148 for spare micro-ingredients and one or more storage locations 150 for spare macro-ingredients.

The beverage dispenser 104 may include one or more network interfaces for communicating directly with devices in the front room or the back room, communicating with devices in the front room or the back room in a local area network (LAN), or communicating with devices remote from a location with the beverage dispenser system 100 via a wide area network (WAN) connection. For example, the beverage dispenser 104 may include networking devices such as a near field communication (NFC) module, a BLUETOOTH module, a WiFi module, a cellular modem, an Ethernet module, and the like. The beverage dispenser 104 may communicate via a direct communication or via a LAN with a user's mobile device 152 or a point-of-sale (POS) device 154 to receive a beverage selection or user profile of a user for configuring the beverage dispenser 104 to dispense one or more beverages based on the beverage selection or user profile. The user profile may include stored favorite beverages for the user, mixed or blended beverages created or stored by the user in their profile, and/or one or more beverage preferences, such as preferred nutritive level. The beverage dispenser 104 may also communicate via a WAN 156 for communicating with one or more remote servers 158 to receive software updates, content updates, user profiles, or beverage selections made via the remote server 158.

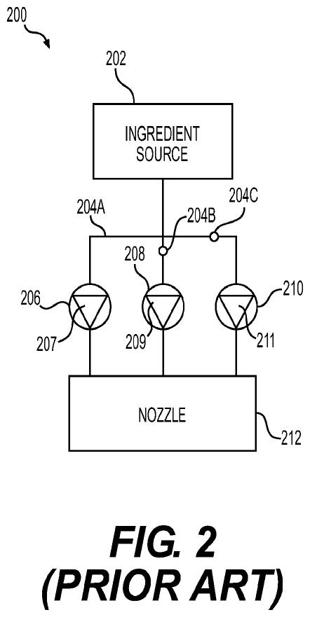

FIG. 2 illustrates an exemplary fluidic circuit 200 with a plurality of independently controlled paths from a single ingredient source 202 to the nozzle 212 suitable for implementing the several embodiments of the disclosure. The fluidic circuit 200 includes an assembly of valves 206, 208, 210 for supplying beverage ingredients to each of the independently controlled paths. Each path includes a pumping or metering device 204A, 204B, 204C for supplying beverage ingredients from the ingredient source 202 to the nozzle 212. The valves in the valve assembly may be opened and closed by respective actuators 207, 209, 211. By having multiple independent paths from the ingredient source 202 to the nozzle 212, a larger range of flow rates are possible than using any one of the pumping or metering devices. For example, for a first flow rate of beverage ingredient from the ingredient source, only one of the pumping or metering devices may be activated. For a second flow rate of the beverage ingredient from the ingredient source, a plurality of the pumping or metering devices may be activated.

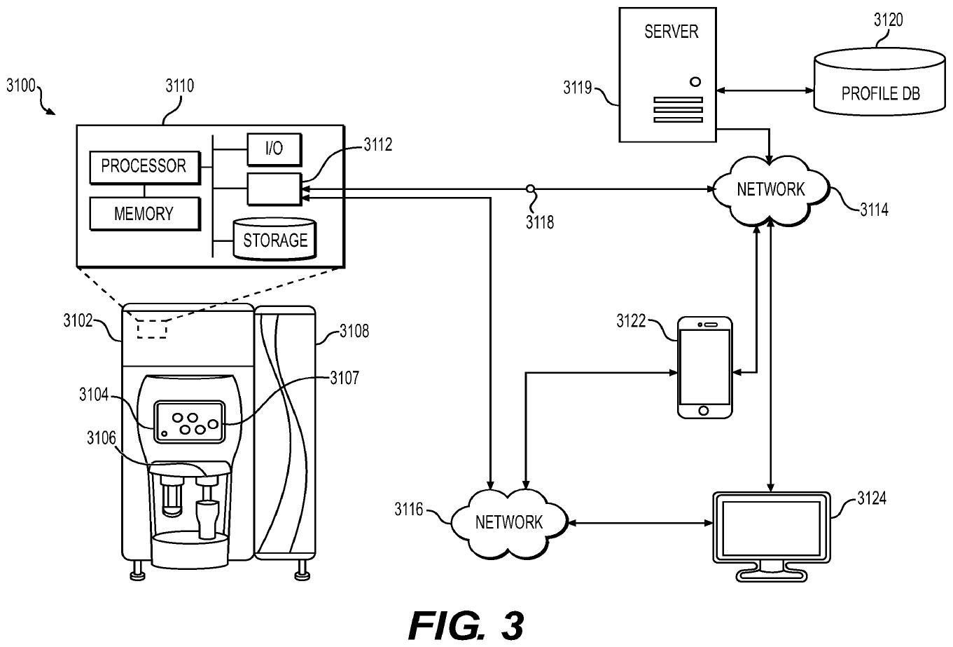

As a general overview of this disclosure, FIG. 3 illustrates an exemplary system 3100 for pre-loading a selection of beverages on a beverage dispenser 3102 according to various embodiments described herein. The beverage dispenser 3102 includes a user interface 3104, such as a display 3107 for selecting a desired beverage to be poured from a nozzle 3106 on the beverage dispenser 3102. In some implementations, the beverage dispenser 3102 includes an ingredient compartment 3108 for storing a plurality of beverage ingredients, such as beverage micro-ingredients. One or more additional beverage ingredients (not shown) may be supplied to the beverage dispenser 3102 from a remote location, such as a back room. The additional beverage ingredients may comprise a sweetener, flavored syrup, carbon dioxide, water, carbonated water, and/or other beverage ingredients. A pump and/or metering device (e.g., positive displacement pump, static mechanical flow control valve, dynamic mechanical flow control valve, shut-off valve, etc.) is coupled between each of the beverage ingredients and a nozzle 3106 for controlling an amount, rate, or ratio of beverage ingredients dispensed for dispensing a selected beverage, as described in more detail below.

The beverage dispenser 3102 may include a control architecture 3110 having a modem 3112 for communicating with external devices. The modem of FIG. 3 is only an example and is not limiting of this disclosure because certain embodiments herein allow for private, non-internet communications on links established directly between a beverage dispenser and a mobile device. Other embodiments can have any other kind of access point for communication purposes, as described below.

While shown as a single component, the modem 3112 may be a plurality of modems for communicating with different communication standards. For example, the modem 3112 may have an ethernet card and/or a cellular modem for connecting (e.g., via a local gateway, not shown) to a wide area network (WAN) 3114, such as the internet. The modem 3112 or other access points described below may additionally include a local wireless communications modem for supporting communication over a local network 3116 using one or more local wireless communication standards, such as WiFi, WiFi Direct, Zigbee, Z-Wave, Bluetooth, or Bluetooth Low Energy (BLE) communications. In addition to the modem 3112, the beverage dispenser 3102 may emit a beacon (not shown), such as a BLE beacon for broadcasting a unique identifier associated with the beverage dispenser 3102. These modern features enable multiple programming and updating techniques with state of the art telecommunications processes.

The beverage dispenser 3102 may be configured to utilize the modem 3112 for communicating 3118 over the wide area network, WAN 3114, with a remote server 3119. In some embodiments, the beverage dispenser 3102 is also configured to receive one or more notifications from the server 3118 regarding how to handle communications with a consumer mobile device 3122 intending to utilize the beverage dispenser 3102. The mobile device 3122 may be a smartphone, smartwatch, personal digital assistant, or any other mobile computing device carried by a consumer. The beverage dispenser 3102 is also configured to utilize the modem 3112 to communicate locally with the consumer mobile device 3122 or a local point-of-sale (POS) device 3124.

In some non-limiting embodiments, a POS device 3124 may be located in the same outlet (e.g., restaurant, convenience store, etc.) as a beverage dispenser 3102. For example, the POS device 3124 may be a self-service order entry system for receiving consumer orders at the outlet. The POS device 3124 facilitates consumers to select a desired food order on the POS device 3124 when placing an order, prior to a consumer utilizing a beverage dispenser 3102. The POS device 3124 may or may not be in communication with the beverage dispenser 3102 via the local network 3116, such as via a wired or wireless communication.

In some implementations, a separate POS device 3124 may be in communication with each beverage dispenser 3102 in a given outlet to facilitate beverage fulfillment. In some implementations, a POS device 3124 may be associated with more than one beverage dispenser 3102.

In one embodiment of this disclosure, the mobile device 3122 avoids requiring a consumer to download a mobile application and yet remains compatible with facilitating personalized interactions with the beverage dispenser 3102. Embodiments of this disclosure avoid the “app” in a number of ways. Operations described herein use a mobile device 3122 with or without an ordinary internet connection (instead of a specialized mobile app) to order a favorite beverage(s), browse options for mixed or blended beverages, and maintain access to updated or future beverage choices that are available at one of the above noted beverage dispensers 3102.

In general, the mobile device 3122 and the beverage dispenser 3102 are configured for bi-directional online communication either directly in a private network, through an establishment Wi-Fi connection, or possibly via external networks, as discussed below. Upon the mobile device being located in sufficient proximity of the beverage dispenser 3102 to scan, photograph, or process an image, such as a QR code 3155, shown on the beverage dispenser display 3107, a communications link 3118 will be facilitated as described herein. Of course, this disclosure is also broad enough for use with other technologies related to beverage dispensers that are not the main focus of this disclosure (e.g., the mobile device 3122 and the beverage dispenser may connect via a web server when the mobile device 3122 is within a first range of the beverage dispenser 3102 or within an outlet in which the beverage dispenser 3102 is located if scanning a QR code is not the most efficient means of connection).

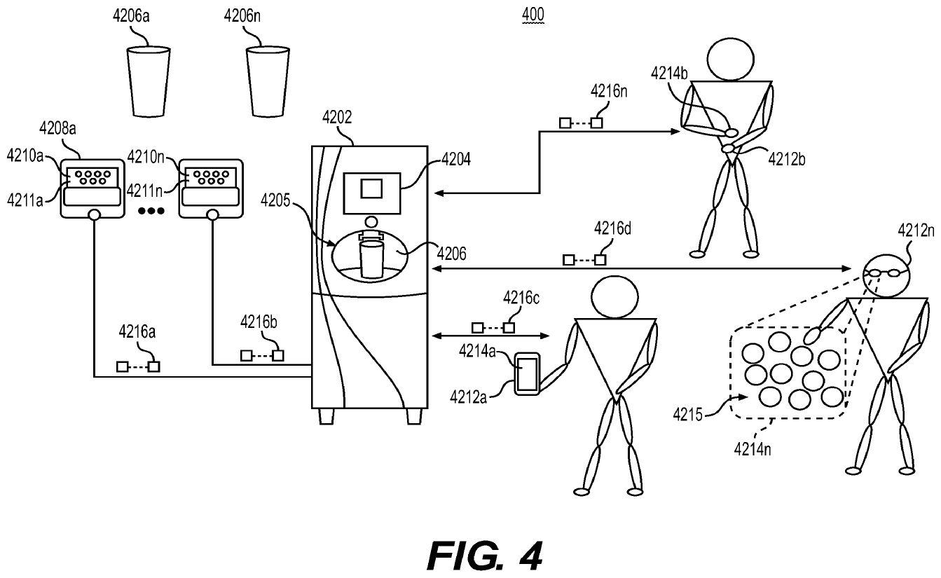

With regard to FIG. 4, an illustration shows a beverage dispensing environment 4200 in which a beverage dispenser 4202 includes an electronic display 4204 for users to control operation of the dispenser 4202 is shown. The dispenser 4202 may include a fill region 4205 in which cups 4206a-4206n (collectively 4206) may be placed for filling with a beverage composed of one or more ingredients. One or more remote electronic devices 4208a-4208n (collectively 4208) may be in communication with the beverage dispenser 4202, and be configured with electronic displays 4210a-4210n (collectively 4210) that may be used by users to order beverages and initiate physical actions to be performed by the beverage dispenser. The electronic devices 4208 may be wire or wirelessly connected to the dispenser 4202. The electronic devices 4208 may be mounted to a wall and/or side of the dispenser, positioned on a table of a restaurant, held in a consumer's hand or disposed anywhere that allows for wired or wireless communication in relation to the dispenser 4202. On the electronic displays 4210 may be user interfaces 4211a-4211n (collectively 4211) that may be the same or similar user interface that may be displayed on the electronic display 4204 of the dispenser 4202. The user interfaces 4211 may display available beverages, ingredients, and/or flavors for selection by users to order beverages to be dispensed by the dispenser 4202, as further described herein.

In addition to the remote electronic devices 4210, user-owned electronic devices 4212a-4212n (collectively 4212) may be utilized to wirelessly interface and communicate with the dispenser 4202. The electronic devices 4212 may include a smartphone or personal digital assistant 4212a, smart watch 4212b, and virtual glasses 4212n.

Other electronic devices that may communicate with the dispenser 4202 may be utilized. In operation, the electronic devices 4212 may use a local wireless communications protocol, such as Wi-Fi®, Bluetooth®, or any other local wireless communications protocol to communicate with the dispenser 4202. Alternatively, the electronic devices 4212 may communicate with the dispenser 4202 via a wide area network, such as a mobile communications network and/or the Internet. In all embodiments, the beverage dispenser 4202 and remote mobile devices 4208, 4212 are equipped with appropriate communications hardware and software to conduct wired and/or wireless communications with each other.

In an example non-limiting embodiment, the dispenser 4202 may display or have affixed thereto a machine readable indicia, such as a QR code or barcode, that may be scanned by the electronic devices 4212 to cause the electronic devices to open a mobile browser that interfaces with the beverage dispenser 4202. The communications may be direct and private without access to any external networks (i.e., a local connection between the dispenser and a mobile device) or a remote server (not shown) may be in communication with the dispenser 4202 via a long distance or local wireless channel. User interfaces 4214a-4214n (collectively 4214) on mobile devices 4212 may replicate a user interface of the dispenser 4202 or be designed to fit the technology available on each of the types of electronic devices 4212. The user wearing the virtual glasses 4202n may select from virtual indicia 4215 to select a desired beverage brand and/or other ingredients. In an embodiment, the electronic devices 4212 may be configured to track eye movement for performing functions on the UIs 4214.

In operation, each of the electronic devices 4210 and 4212 may communicate wireless communications signals 4216a-4216n (collectively 4216) between the dispenser 4202 and wirelessly connected electronic devices 4210 and 4212. The wireless communications signals 4216 may include data used to enable a user to select selections (e.g., beverage, ingredients, flavors, mix percentages, etc.) for dispensing a beverage by the dispenser 4202. The data may include any data used for display and selection on the electronic devices 4210 and 4212 and/or display and/or control of the dispenser 4202 for queuing and/or dispensing by the dispenser 4202. In an embodiment, the data may include identification data associated with the user (e.g., user name, image, avatar, photograph, etc.) for storage and display on the electronic device 4204 of the dispenser 4202 so that the user or store operator, may readily identify and select a selected beverage to be poured by the dispenser 4202 for the user.

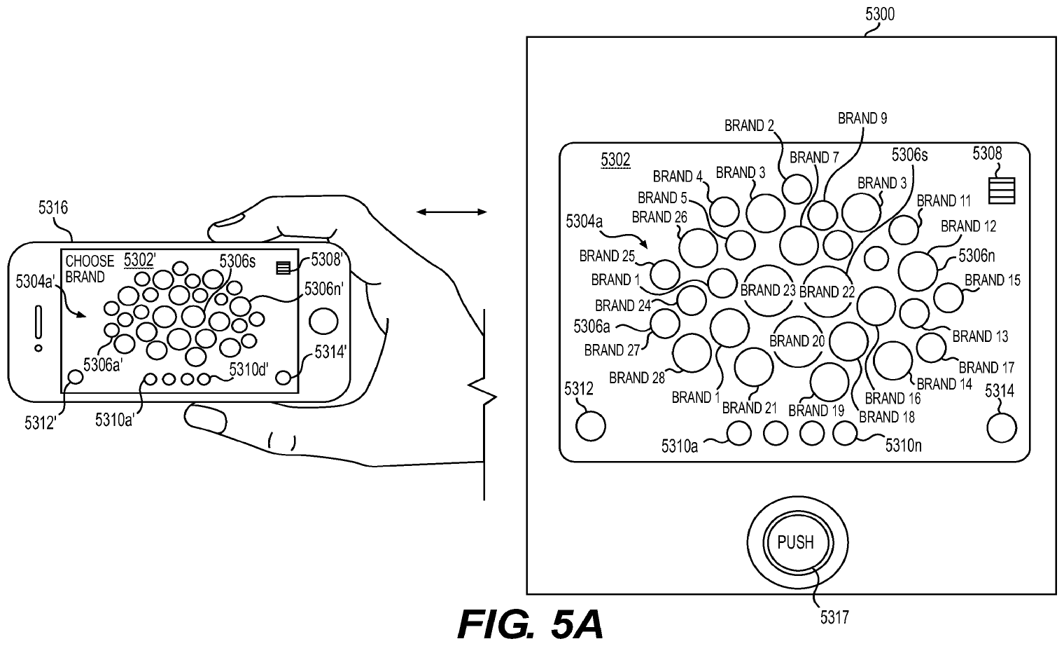

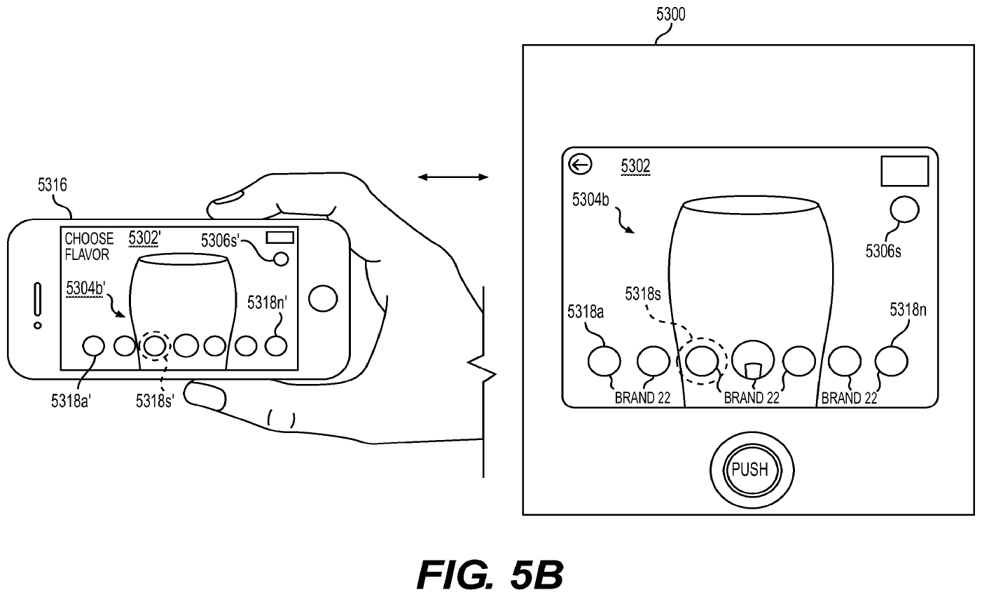

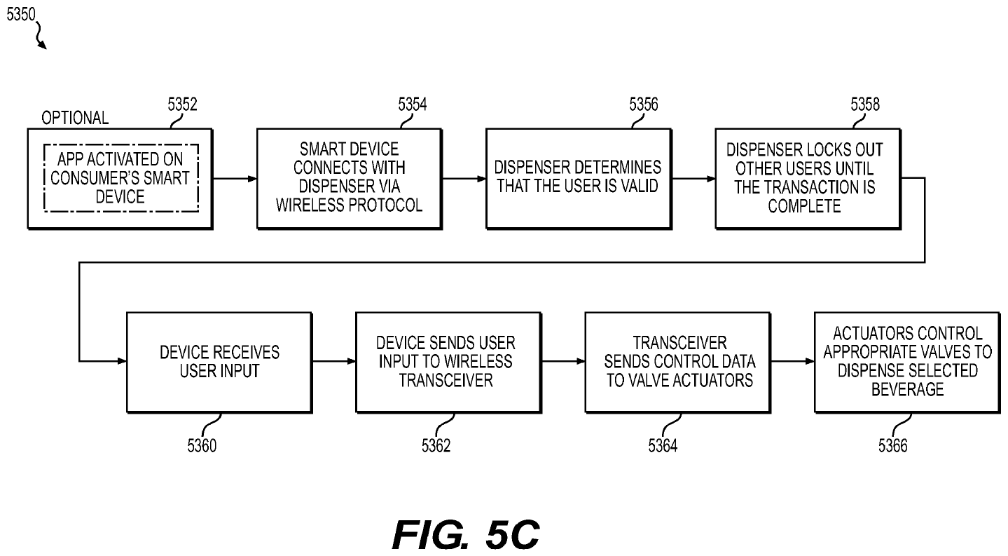

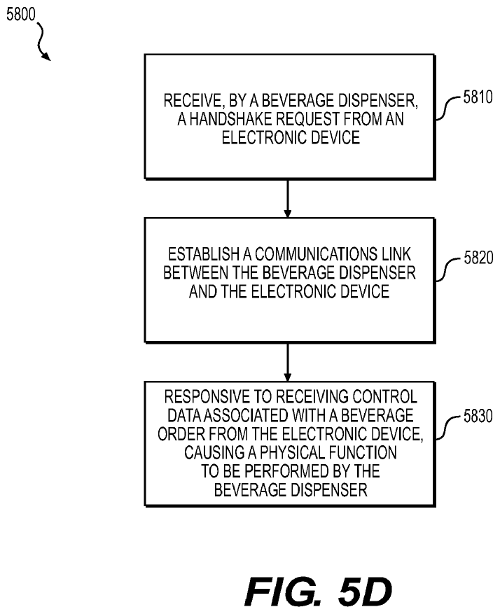

With regard to FIGS. 5A and 5B, illustrations of a beverage dispenser 5300 including electronic display 5302 and a mobile device 5316 of a user both displaying a common user interface 5304a and 5304b are shown. The electronic display 5302 includes a user interface 5304a that shows selectable icons 5306a-5306n (collectively 5306) for a user to select available brands of a beverage to be dispensed by the dispenser 5300. A machine readable indicia 5308 (e.g., quick reference (QR) code) may be displayed for the electronic device 5316 to image or scan for registration and/or to establish communications with the dispenser 5300. Selectable control elements 5310a-5310n (collectively 5310) may be used to move through or select from a number of control screens for selecting and pouring a beverage. A “water” soft-button 5312 may be available for a user to select water as a beverage to be dispensed by the dispenser 5300. An available mix soft-button 5314, such as “LeBron's mix” soft-button (or display element), may be available for a user to select a pre-set mix of brands, ingredients, and/or flavors by another user of the electronic device 5316 may be displayed. As shown, a user has selected a brand by touching selectable icon 5306s.

On the mobile electronic device 5316, an electronic display 5302′ may display a complementary user interface 5304a′ thereon. Each of the selectable elements that are displayed on the user interface 5302 of the dispenser 5300 may also be displayed for a user to select a beverage to be dispensed by the dispenser 5300. As previously described with regard to FIG. 2, the mobile electronic device 5316 may communicate with the dispenser 5300 via a local or long-range wireless communications protocol. As shown, the selectable icon 5306s′ has been selected, and such a selection may be displayed on the electronic display 5302 in response to a communication from the electronic device 5316 to the dispenser 5300. In an embodiment, the icon 5306 may dynamically in real-time show the icon 5306′ being selected (e.g., change color as the user touches the icon 5306′) by the electronic device 5316 communicating signals to the dispenser 5300. Other actions being performed on the user interface 5304b′ may be displayed on the user interface 5304b′. A push-button 5317 may enable the user to dispense a selected beverage by the dispenser 5300. In an alternative embodiment, a soft-button may be available for pressing on the electronic display 5302 to cause the selected beverage to be dispensed by the dispenser 5300.

With regard to FIG. 5B, the dispenser 5300 is shown to include a different user interface 5304 of the electronic display 5302. User interface 5304b may display an icon 5306 of the selected brand from the previous user interface 5304a along with selectable icons 5318a-5318n (collectively 5318) representative of different flavors of the selected brand displayed by the icon 5306s. As shown, a user may select one of the selectable icons 5318, such as “Sprite Peach” selectable icon, to select a particular flavor of the brand. As previously described, a user may operate the user interface 5302′, which causes corresponding actions to be displayed in real-time on the user interface 5302. For example, in response to the user touching a selectable icon 5318′, a corresponding one of the icons 5318 on the user interface 5302 may appear to be selected simultaneously. Moreover, if the user performs a virtual reality action on the user interface 5302′, then a corresponding virtual reality action may be performed on the user interface 5302′. For example, if the user “flicks” a virtual ball or beverage can toward the dispenser 5300, then the user interface 5302 may provide for a corresponding virtual reality interface, such a displaying cups in which the ball or beverage can may be placed to place the beverage order, receive a reward, or otherwise.

With regard to FIG. 5C, a flow diagram of an illustrative process 5350 for a user to select and communicate beverage selections from a mobile electronic device or smart device to a beverage dispenser is shown. The process 5350 optionally starts at step 5352, where an app may be activated on a consumer's smart device. In activating the app, the consumer may download the app from an app store, as understood in the art. In addition, the consumer may enter his or her information, including a user ID, image, demographic information, biographical information, and/or other information so that the app may be capable of communicating information to a dispenser for identification purposes along with a beverage selection.

The app feature at 5352 is entirely optional as explained below. Embodiments of this disclosure encompass communications with a traditional “app” oriented approach and other formats that avoid using an “app” all together by utilizing private local connections described below. At step 5354, the smart device may connect with a beverage dispenser via and local wireless protocol, as previously described. At step 5356, the dispenser may determine that the user is valid. After determining that the user is valid at step 5356, the process 5358 may continue at step 5358, where the dispenser may lock out other users until the transaction with the user is complete. In an alternative embodiment, the dispenser may be configured to enable multiple users to simultaneously perform a transaction, but load other beverage selections into a queue or random selectable list for later selection for dispensing by the other user or consumer to dispense his or her selected beverage.

At step 5360, the smart device may receive a user input that include selection of a beverage. The selection of the beverage may include one more beverage brands, flavors, or otherwise. At step 5362, the smart device may send the user input to a wireless transceiver of the dispenser, which, in turn, may send the user input to a human-machine interface (HMI), or as discussed in detail herein, at step 5364, the transceiver may direct control data to valve actuators in the beverage dispenser. At step 5366, the actuator may interpret the user input as requests to select and/or to dispense the selected beverage from the dispenser into a vessel, such as a cup, placed beneath a nozzle of the dispenser, as previously described.

FIG. 5D illustrates an exemplary entity sequence diagram 5800 for a communication session between a mobile device and a beverage dispenser according to various embodiments of the disclosure. The steps include receiving 5810, by a beverage dispenser, a handshake request from an electronic device, such as but not limited to a beverage consumer's handheld mobile device. This may be accomplished with or without connection to a web server, as explained below, but a communications link of appropriate protocol is established at 5820 between a beverage dispenser and a consumer's electronic device or mobile device. The sequence diagrams in this disclosure show optional use of a server as an intermediary to facilitate a communications link between the mobile device and the beverage dispenser.

The figures illustrate exemplary diagrams for communication sessions between a mobile device 3122 and the beverage dispenser 3102 according to various embodiments of this disclosure. In the implementations shown and without limiting this disclosure, the beverage dispenser 3102 may include communications resources such as, but not limited to, a first wireless communication device and a second wireless communication device configured to broadcast data for wireless communications with internet networks, other computers, and/or the mobile devices 3122.

Considering FIG. 3 in terms of communications, the schematic diagram illustrates how a mobile device 3122 may implement a communications link 3118 with or without a web server to a beverage dispenser 3102 for completing an entire instance of beverage fulfillment operations. Without limiting this disclosure, an instance of beverage fulfillment includes all of the steps, communications, and beverage dispenser operations by which a consumer selects, completes, and can receive a beverage in a cup that is ready for consumption. The communications links of the schematic of FIG. 3 illustrate that in certain optional embodiments, the beverage dispenser 3102 utilizes a communications device, such as a modem 3112, to connect to a network 3114 offering internet connections to a web server 3119. In other embodiments described herein, communications between the mobile device and a beverage dispenser may be completely private in a direct local network without use of web servers and internet connections. In certain embodiments, vendors of beverages that are dispensed through the beverage dispenser 3102 may utilize a private network, providing specialized and secure connections to particular devices either limited to a particular establishment or connected via known internet service providers, to connect beverage dispensers, whether located in a single building or dispersed across various geographic regions, to servers, computers, and peripheral equipment described below.

FIG. 3 is a global schematic of many ways in which a mobile device 3122 establishes secure communications with a beverage dispenser 3102. The schematic encompasses purely local intranet options (i.e., the mobile device only receives a web page or landing page served directly from the beverage dispenser without connecting to any external networks for beverage fulfillment). In other embodiments, a mobile device 3122 and a beverage dispenser 3102 may communicate across an establishment wide area network or local area network. These embodiments all adapt the beverage dispenser as an intermediary for a user controlling beverage dispensing operations from a remote and/or mobile device. After communications data from a beverage dispenser connection leaves its private network 3116 for communication with consumer operated mobile devices 3122 on public communications networks, a beverage dispenser connection may connect to load balancing equipment and gateway hardware for managing secure communications between mobile devices 3122 and a network of beverage dispensers. Optionally, network traffic flows through a load balancer to implement web communications and data processing operations, such as, but not limited to services provided, at least in part, by Amazon Web Servers (AWS). In some embodiments, traffic egresses the AWS and into a public internet service provider network, for communications on global communications networks serving mobile devices operated by beverage consumers. At the retailer, a consumer uses a mobile device 3122 to select beverage fulfillment commands that are transmitted across the above-described network to complete an instance of beverage fulfillment at a beverage dispenser 3102.

FIG. 4 illustrates another version of completing an instance of beverage fulfillment and the communications environment therein. FIG. 4 may be used to show communications and beverage fulfillment operations between a mobile device 4212 and a beverage dispenser 4202. Many components shown in FIG. 4 are optional, as this disclosure encompasses embodiments in which a beverage dispenser 4202 and a mobile device 4212 are connected to each other with and without other connections to external networks, the Internet, or cloud services. In one non-limiting embodiment, the beverage dispenser 4202 establishes a communications connection to an application program interface (“API”) via a gateway (“GW”) initiating an appropriate web socket protocol (e.g. AWS) and in one embodiment, passes a serial number of the dispenser 4202 to the web server. The API gateway server distributes a security token to the beverage dispenser 4202, upon connecting to the beverage dispenser 4202, and sends another every ten seconds. The beverage dispenser 4202 displays, on a graphical user interface 4204, a barcode that includes an encrypted URL and at a communications connection, the beverage dispenser 4202 sends that barcode to the API gateway server 4223 along with the previously received security token, which is updated every 10 seconds. A customer scans the 2D barcode (i.e., the QR code 155), approves launching a web browser on the mobile device 4212, and opens a mobile version of a website on the mobile device 4212. The browser on the mobile device 4212 connects to the API gateway web socket and receives a validation token in bidirectional communication between the mobile device 4212 and an API gateway server. Beverage fulfillment occurs via this connection. The API gateway server sends the beverage dispenser 4202 notice that a mobile device 4212 is connected. The dispenser updates the 2D barcode to indicate that the consumer is connected. The consumer uses graphical user interface selection options displayed on the mobile device 4212, received from the API gateway server, to select a beverage and presses a pour icon, an ice icon, or a stop icon, among other selections in various embodiments. In some embodiments, the selections may include mixing beverage selections at desired proportions in a single cup. The API gateway relays the pour events from the mobile devices to the dispenser. The consumer clicks done on the mobile device user interface, there is a timeout, or there is another activity requiring termination of beverage fulfillment.

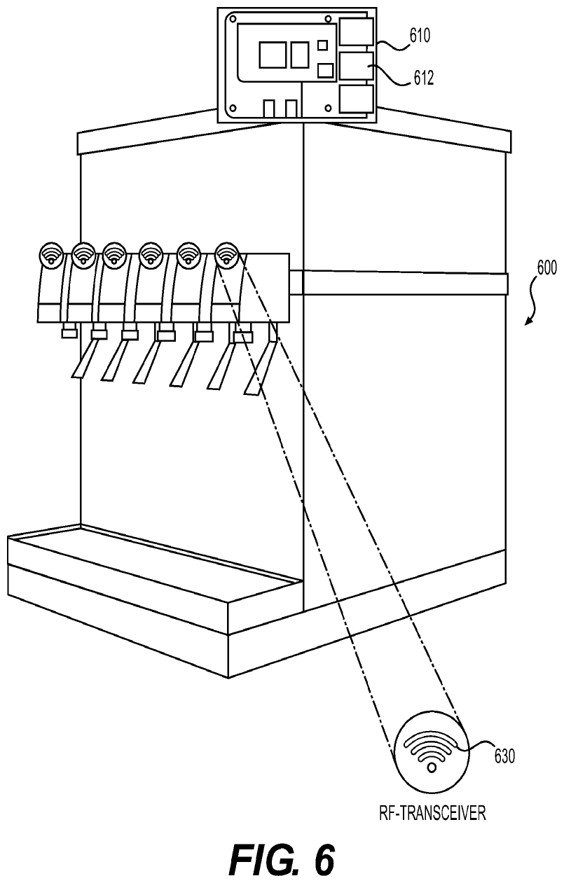

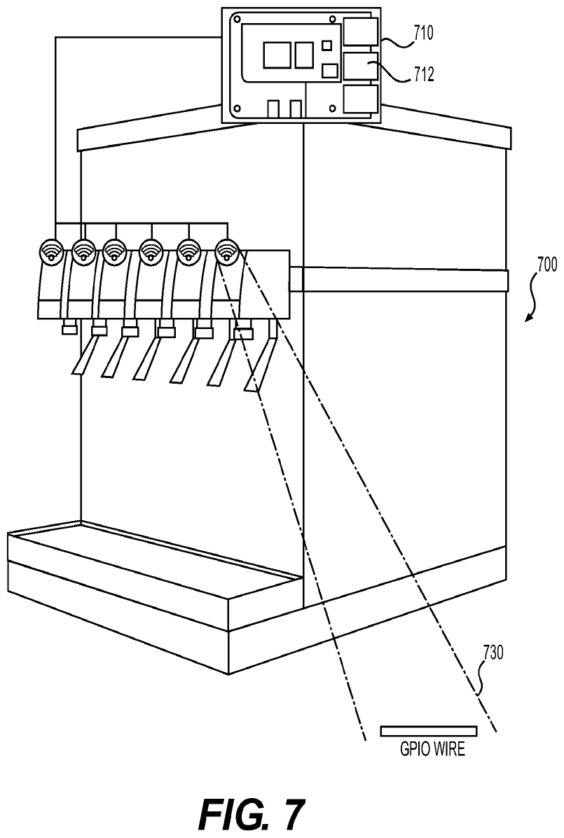

In light of the above described hardware and communications environments for beverage fulfillment, this disclosure incorporates a system for controlling a beverage dispenser to deliver a beverage from a nozzle. The nozzle may be a traditional soda fountain nozzle as shown in FIGS. 6 and 7, or a single, multi-beverage nozzle 3106 as illustrated in the dispenser of FIG. 3. As used in the embodiments above, a beverage dispenser may be a manual dispenser as illustrated in FIGS. 6 and 7 or may be a “smart” beverage dispenser as illustrated in FIGS. 2-5 having a computer 610, 710 with memory connected to the beverage dispenser. In one embodiment, the computer 610, 710 may be a single board computer 610, 710 that may be installed within a housing of the beverage dispenser. In at least one embodiment, the beverage dispensers 3102, 4202, 600, 700 include at least one wireless communications access point 612, 712 connected to the beverage dispenser and configured by the computer 610, 710. The term “wireless communications access point 612, 712” includes, but is not limited to, Wi-Fi, Bluetooth®, a wireless router that is integral with the computer 610, 710, and even systems having custom software corresponding to a mobile application (or “app”) used to communicate with the access point 612, 712 from a remote device. Communications utilizing these protocols and hardware combinations may implement numerous kinds of security algorithms, and in at least one embodiment, the memory of the computer 610, 710 is accessible by a processor implemented with the beverage dispenser, and may store cryptographic software to apply to communications to and from the access point 612, 712.

In one non-limiting embodiment, this disclosure provides additional features related to the above described FIGS. 5A-5D, particularly in regard to communications and systems for connecting a mobile device 5316 (e.g., a user device, mobile computer, or personal device) to the beverage dispenser 3102, 4202, 600, 700 and controlling the beverage dispenser remotely. As previously, discussed, embodiments of beverage dispensers 3102, 4202, 600, 700 may utilize all available communications hardware and software to connect, in electronic communication, mobile devices, consumer devices, computers, phones, and the like with computer systems providing physical functions, i.e., pouring, mixing, and/or dispensing, at the beverage dispenser 3102, 4202, 600, 700. The above noted communications cover embodiments utilizing cloud network communications, web or Internet communications, intranet connections, local area networks, and private networks within an establishment.

Considering private networks within establishments (e.g., networks that are isolated from networks that are external to an establishment or location), certain vendors and retail outlets prefer for customers and consumers of beverages to consummate sales and beverage consumption entirely in-house, without relying on extensive outside network communications. For example, and without limitation, a cruise ship relies upon expensive satellite communications for internet connections. Therefore, cruise ship customer service plans make every effort to avoid requiring expensive satellite Internet connections and other global telecommunications to implement self service beverage fulfillment at a smart beverage dispenser. These kinds of establishments or beverage vendors prefer to control individual one-to-one direct connections between their in-house equipment and consumers mobile devices. These kinds of ad hoc or intranet connections in an establishment are discussed in more detail below.

Traditional instances of remotely controlling a beverage dispenser 3102, 4202, 600, 700 relied upon wireless communications that may be routed over the internet and through cloud based services before completing a beverage order at the beverage dispenser, even when the dispenser is only a few feet away. One embodiment of this disclosure avoids using these kinds of external networks and/or telecommunication services outside a wireless communications range of a transceiver located at the beverage dispenser. This disclosure, therefore, includes installing, or making locally accessible on the computer 610, 710 associated with any beverage dispenser 3102, 4202, 600, 700, a beverage selection webpage hosted by the computer 610, 710. The beverage selection web page is hosted by the computer of the beverage dispenser for wireless transmission within a range of the access point 612, 712. The computer 610, 710 at the beverage dispenser is configured to receive beverage selection data from a remote rendering 5302, illustrated in FIGS. 5A, 5B, of the beverage selection website on a user device (e.g., on a phone, a tablet, or any computer 610, 710 in use at the time). The beverage transaction data comprises dispenser usage data, dispenser diagnostic data, beverage pour data, beverage volume data, dispenser location data, and/or remote device access data. Upon receiving the beverage selection data, the computer 610, 710 takes action to control, electronically, an assembly of valves 206, 208, 210 connected to at least one nozzle 212 in the beverage dispenser. More precisely, the computer 610, 710 processes the beverage selection data to control an actuator 207, 209, 211 in communication with the computer 610, 710 and configures the valves 206, 208, 210 and actuators 207, 209, 211 in an open position or a closed position. In non-limiting embodiments, control data may be derived from the beverage selection data, wherein the computer 610, 710 transmits the control data to the actuator 207, 209, 211 according to the beverage selection data. In the open position, the respective valve actuator 207, 209, 211 is operable to dispense a beverage fluid from a nozzle. In certain non-limiting embodiments, the actuator 207, 209, 211 is an electronic actuator 207, 209, 211 in data communication with the computer 610, 710.

The computer 610, 710 may communicate with the actuator 207, 209, 211 by transmitting the control data and control instructions to the actuator 207, 209, 211 and electronics within the actuator 207, 209, 211 by either a wired data connection or a wireless data connection. In certain embodiments as shown in FIG. 6, at least one radio frequency (RF) transceiver 630 may be in wireless communications with the computer 610, 710 610, 710 and in data communication with the actuator 207, 209, 211, wherein the RF transceiver receives the control data from the computer 610, 710 and is configured to wirelessly transmit the control data to the actuator 207, 209, 211 according to the beverage selection data. The RF transceiver may be in wireless data communication with the computer 610, 710 via the access point 612, 712, or, the RF transceiver may be connected to the computer 610, 710 with signal connectors that extend from general purpose input and output connections on a digital serial pin bus connected to the computer 610, 710. Other hardware connecting the RF transceiver 630 to the computer 610, 710, such as a corresponding transceiver at the computer 610, 710 is also within the scope of this disclosure. In some embodiments, the signal connectors, therefore, may be directly wired connections connecting the actuator 207, 209, 211 to the computer 610, 710 for data communication. Numerous options are available for actuator 207, 209, 211 used in this disclosure, including electronically controlled actuator 207, 209, 211 and/or dispenser level solenoid valves.

The embodiment above describes a web page served directly from a computer 610, 710 that is connected to and operating, within or in connection with, a beverage dispenser and associated system components that complete consumer beverage fulfillment operations. With this web page served from the local computer 610, 710, and not from an internet connection, cloud server, or outside network, the access point 612, 712 may be characterized as an intranet node providing communications infrastructure for the beverage dispenser and remote devices without an internet connection.

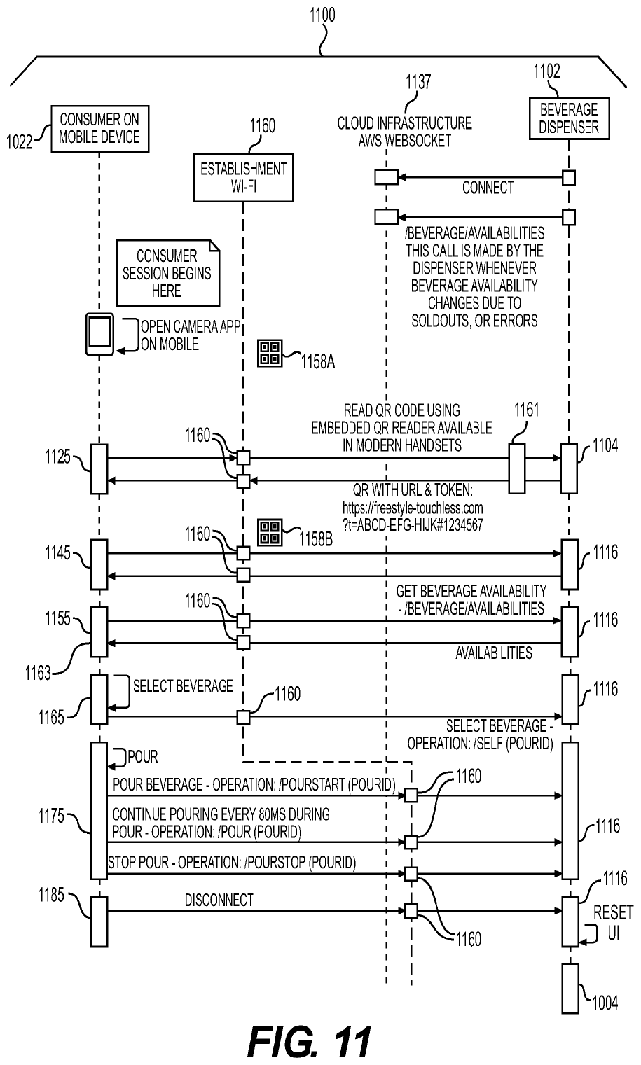

This disclosure, however, does include embodiments that serve the web page to consumer devices in other setups. In another non-limiting embodiment, the access point 612, 712 may be a Wi-Fi connection to an establishment router 1160 that is separate from the computer 610, 710 and provides a connection to the internet for the computer 610, 710 and remote devices. Accordingly, it is within the scope of this disclosure for the beverage dispenser to serve the beverage selection webpage over an establishment connection to the internet, such as an establishment Wi-Fi router, to the remote devices. This embodiment is shown in more detail in FIG. 11. This embodiment, therefore, may also utilize an external modem 1137 connected to the access point 612, 712 to deliver beverage transaction data to remote servers over the internet. The beverage transaction data includes but is not limited to dispenser usage data, dispenser diagnostic data, beverage pour data, beverage volume data, dispenser location data, and/or remote device access data. As in other embodiments discussed herein, the computer 610, 710, the processors, and networks may utilize cryptographic software to enhance security. In certain embodiments, security actions disallow access to the external modem from the access point 612, 712 communicating with remote devices.

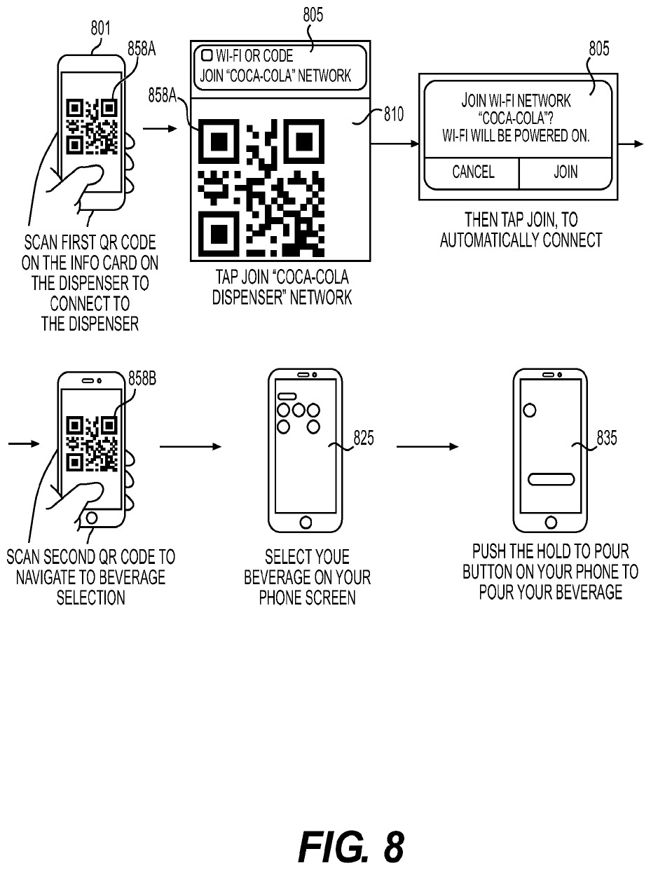

The description above explains hardware and communications options for hands free, wireless beverage fulfillment in a wide variety of local connections, private establishment connections and external network connections as needed. In practical application, the systems and methods of this disclosure allow for checks and double checks in data security, in data accuracy, and in consumer intent for beverage selections being transmitted to the beverage dispenser for physical beverage fulfillment. One of those checks is shown in FIG. 8 and begins with a display on the beverage dispenser displaying a first QR code 858A that may include embedded data configured to initiate bidirectional wireless communications between the access point 612, 712 at the beverage dispenser and an electronic mobile device 801 that is remote with respect to the beverage dispenser. A graphical user interface connected to the computer 610, 710 in the beverage dispenser is configured to show the first QR code and any additional QR codes. Once a consumer achieves a data communication connection with the beverage dispenser and associated computer 610, 710, optionally via a scan of the first QR code 858A, the data communications connection may be used to initiate beverage fulfillment. In one embodiment, a second display on the beverage dispenser displays a second QR code 858B with corresponding data configured to initiate beverage selection from the webpage stored on the computer 610, 710 directly associated with the beverage dispenser. The second QR code, therefore, allows a consumer device to initiate a remote rendering 825, 835 of the webpage, served from the beverage dispenser and associated computer 610, 710, on the remote mobile device 801. The remote rendering of the website, which has been described in one embodiment as being served from an intranet node located at the beverage dispenser, allows for a consumer device to receive computer coded instructions via communication with the access point 612, 712. This communication enables beverage control buttons to be displayed on the remote rendering of the webpage and in numerous embodiments, the beverage control buttons, also shown in FIGS. 5A, 5B, correspond to the beverage selection data transmitted to the computer 610, 710 at the beverage dispenser.

The beverage control buttons are illustrated in FIGS. 5A, 5B and 8 and may include pour buttons that may be configured for establishing a feedback loop with the processor. At least one of the beverage control buttons on the remote rendering 825, 835 of the webpage served from the beverage dispenser is a pour button configured to initiate periodic pour commands from the computer 610, 710 to the actuator 207, 209, 211. The periodic pour commands are separated by a time interval and controlled by beverage selection data originating from the pour button. The computer 610, 710 uses the beverage selection data and the beverage dispensing software to dispense a selected beverage from the dispensing nozzles according to a flow control module stored in the memory.

Considering the overall transaction of beverage fulfillment in more detail, a consumer may prefer to use embodiments herein instead of touching a beverage dispenser or standing in a queue with other customers. After all, wireless embodiments of this disclosure provide resources to avoid close contact with the dispenser or other people in an establishment, so long as a consumer's mobile device is within a certain operation range.

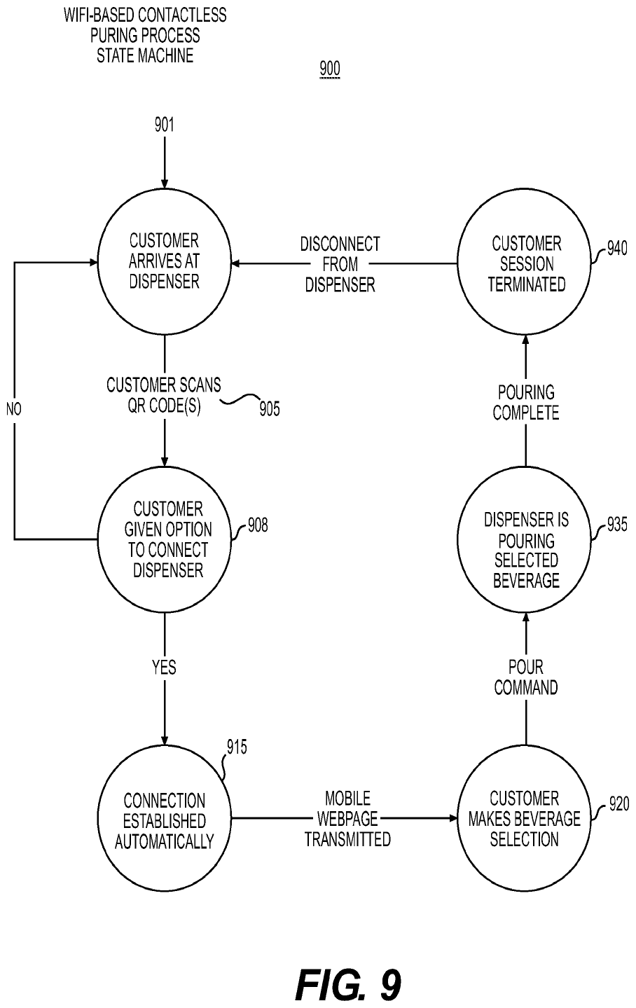

Methods of this disclosure implement steps, such as those shown in FIG. 9, utilizing the system embodiments described herein. For example, and without limiting this disclosure, at step 901, a customer arrives at a beverage dispenser in an establishment. The customer may be anywhere within wireless communications range of the equipment in use, i.e., within communications range of both an access point 612, 712 at the beverage dispenser computer 610, 710 and a transceiver on a mobile device 801. At one point 905, the customer scans a first QR code 858A to establish communications between the customer's remote mobile device 801 and the beverage dispenser. At 908, therefore, the customer is given an option on their own device to connect to the dispenser. Upon declining the connection, the system and methods start over and the system is in a ready state for the next operation. Upon accepting a communications connection option, the computer 610, 710 of the beverage dispenser initiates the data communications connection at 915. As described above, this connection allows for the computer 610, 710 of the beverage dispenser to serve a mobile web page allowing the customer to make a beverage selection at 920. The customer then has access to all of the beverage selection buttons on their mobile device that would be available to a customer manually operating the beverage dispenser. For example, and without limitation, a pour button displayed on a mobile device 801 used by a consumer will cause a pouring of a selected beverage, which was also determined by a beverage selection button on the mobile device 801.

Numerous systems and equipment may be used to determine when a customer's beverage fulfillment selection is done. For example, a pour command may be a timed pouring, a volumetric pour, a weight based pour, or even a pour measured by imaging a beverage that has been dispensed into a consumer's cup or other container. Appropriate sensors and computer imaging equipment may be installed at the beverage dispenser accordingly.

This disclosure, therefore, encompasses a computer implemented method shown graphically at FIG. 8. for controlling a beverage dispenser delivering a beverage to a nozzle 212. The method includes hosting a beverage selection webpage in a computerized memory connected to a computer 610, 710 installed in the beverage dispenser. The computer 610, 710 is also utilized to establish an access point 612, 712 to the webpage within the computer 610, 710. The computer 610, 710, therefore, is configured by receiving beverage selection data corresponding to the webpage at the access point 612, 712. The beverage selection data is transmitted to the computer 610, 710 from other devices, including a consumer's mobile device. The computer 610, 710 transmits control data, configured according to the beverage selection data, to an actuator 207, 209, 211 to open and close a valve that distributes the beverage to the nozzle.

The connection between the computer 610, 710 at the beverage dispenser and the mobile device 801 begins by initiating communications at the access point 612, 712 with a first QR code 858A. This connection enables the computer 610, 710 to serve the webpage for a remote rendering of the webpage 825, 835 that is configured to receive beverage selection data from an external computer, or mobile device 801, in communication with the access point 612, 712. Overall, the computer 610, 710 uses received beverage selection data in controlling the actuator 207, 209, 211 with communications transmitted from the access point 612, 712 to a respective RF transceiver 630 connected to the actuator 207, 209, 211. In other embodiments, the computer 610, 710 controls the actuator 207, 209, 211 with communications transmitted across a signal connector extending from a digital serial pin bus on the computer 610, 710 to the actuator 207, 209, 211.

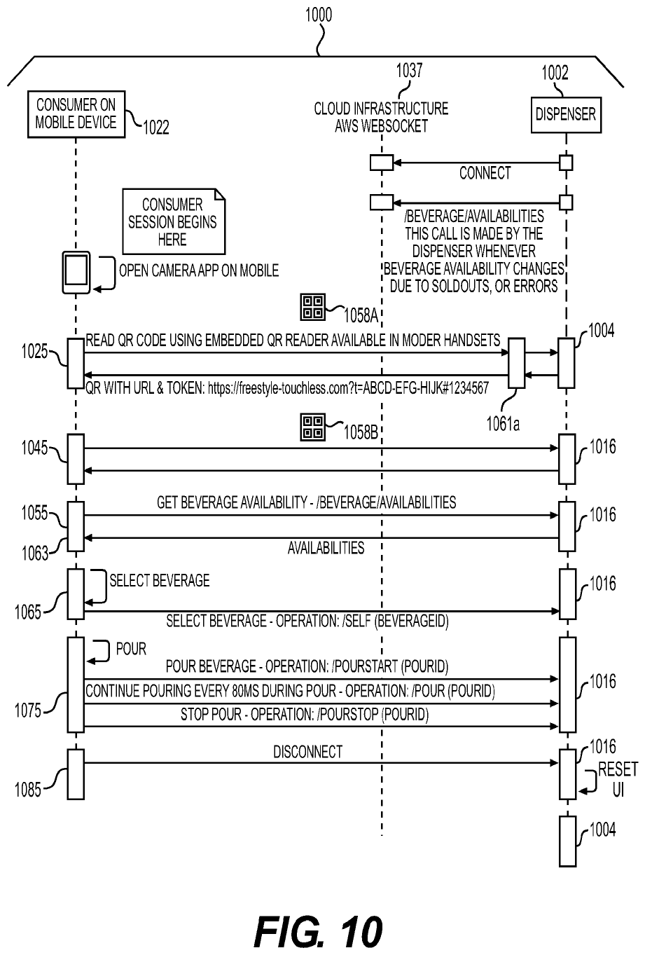

This method is shown graphically at FIGS. 10 and 11.

At 1025, a QR code 105A may be displayed on the beverage dispenser 1002 graphical user interface 1004 for reading by a mobile device 1022 with an indication that it can be used by mobile phones for a contactless experience. As shown at 1025, consumers, therefore, are able to scan the QR code 1058A with their mobile camera and activate the experience via a local, non-Internet connection 1061A to the dispenser 1002 without installing a mobile app. The mobile phone, or mobile device 1022, will prompt the user to make sure they want to open the contactless experience by requiring the user to scan a second barcode 1058B displayed on the beverage dispenser 1002 at the user interface 1004. In some embodiments the mobile experience may open in under three seconds on an LTE smart phone with good signal reception. The QR codes 1058A, 1058B will have an embedded security token so that only someone within a planned operating and communications range of a beverage dispenser 1002 can activate the experience. Once the consumer has opened the mobile experience, they will be connected to the beverage dispenser 1002 via a direct connection with a computer 610, 710 associated with the beverage dispenser 1002. In non-limiting embodiments, described above, this direct connection is described as a direct connection to an intranet node at the beverage dispenser, in the absence of an external network connection. This will have all of the qualities of a direct connection from the perspective of the consumer.

As noted in FIG. 10, the beverage dispenser 1002 is continuously updating its connection with the mobile device 1022. A computer 610, 710 associated with the beverage dispenser 1002 is equipped to generate and display updated QR codes 1058A, 1058B and associated communication tokens via periodic security updates between the beverage dispenser 1002 and a mobile device 1022. The updated QR codes are shown in a display associated with a graphical user interface 1004 on the beverage dispenser. At step 1055, the mobile device 102 receives updates to its mobile website connection to the beverage dispenser 1002 for proper display of beverage availability and other updates relate to using the beverage dispenser. These communications are secured by previously received communication tokens described above and discussed below in more detail.

It is notable that FIG. 10 does show at 1037 that other optional connections are available in different embodiments of this disclosure. In one non-limiting embodiment, the system and methods of remote beverage fulfillment may allow for the beverage dispenser 1022 to have a different connection to external networks, and even connect to the Internet and cloud infrastructure equipment. This connection may be used to track beverage transaction data described above for use by the vendors.

Regardless of whether the embodiment serves a webpage in a restricted, local connection only between the mobile device 1002 and the beverage dispenser 1004 or whether another embodiment utilizes an establishment local area network or other internet connections, FIG. 10 illustrates the receipt and display of a remote rendering of a webpage 1063 served from the beverage dispenser at step 1055. At step 1065, a user or consumer uses the webpage to see options as described in FIGS. 5A and 5B on their mobile device 1022. Step 1065 illustrates a manual beverage selection via the remote rendering of the webpage and the transmission of beverage selection data back to the beverage dispenser 1002.

In FIG. 11, another non-limiting embodiment is illustrated in which communications between a consumer's mobile device 1122 and a beverage dispenser 1102 are completed via an establishment Wi-Fi connection 1160. The establishment may be any geographic location in which a beverage dispenser 1102 is positioned for beverage fulfillment via a mobile device 1122 within the Wi-Fi range of the establishment Wi-Fi connection 1137. At step 1125, a QR code 1158A may be displayed on the beverage dispenser 1102 graphical user interface 1104 for reading by a mobile device 1122 with an indication that it can be used by mobile phones for a contactless experience. As shown at 1125, consumers, therefore, are able to scan the QR code 1158A with their mobile camera and activate the experience via a local connection 1161 to the dispenser 1102 either with or without installing a mobile app. The mobile phone, or mobile device 1122, will prompt the user to make sure they want to open the contactless experience by requiring the user to scan a second barcode 1158B displayed on the beverage dispenser 1102 at the user interface 1104. In some embodiments the mobile experience may open in under three seconds on an LTE smart phone with good signal reception. The QR codes 1158A, 1158B will have an embedded security token so that only someone in front of a beverage dispenser 1102 can activate the experience. Once the consumer has opened the mobile experience, they will be connected to the beverage dispenser 1102 via a direct connection with a computer 610, 710 associated with the beverage dispenser 1102. In non-limiting embodiments, described above, this direct connection is described as a direct connection to an intranet node at the beverage dispenser or an Internet connection via the Wi-Fi at the local establishment. This will have all of the qualities of a direct connection from the perspective of the consumer.

As noted in FIG. 11, the beverage dispenser 1102 is continuously updating its connection with the mobile device 1122. A computer 610, 710 associated with the beverage dispenser 1102 is equipped to generate and display updated QR codes and associated communication tokens via periodic security updates between the beverage dispenser 1102. The updated QR codes are shown in a display associated with a graphical user interface 1104 on the beverage dispenser. At step 1155, the mobile device 1122 receives updates to its mobile website connection to the beverage dispenser 1102 for proper display of beverage availability and other updates relate to using the beverage dispenser. These communications are secured by previously received communication tokens described above and discussed below in more detail.

It is notable that FIG. 11 does show at 1137 that other optional connections are available in different embodiments of this disclosure. In one non-limiting embodiment, the system and methods of remote beverage fulfillment may allow for the beverage dispenser 1102 to have a different connection to external networks, and even connect to the Internet and cloud infrastructure equipment. This connection may be used to track beverage transaction data described above for use by the vendors.

Regardless of whether the embodiment serves a webpage in a restricted, local connection only between the mobile device 1102 and the beverage dispenser 1104 or whether another embodiment utilizes an establishment local area network 1160 or other internet connections, FIG. 11 illustrates the receipt and display of a remote rendering of a webpage 1163 served from the beverage dispenser at step 1155. At step 1165, a user or consumer uses the webpage to see options as described in FIGS. 5A and 5B on their mobile device 1122. Step 1165 illustrates a manual beverage selection via the remote rendering of the webpage and the transmission of beverage selection data back to the beverage dispenser 1102.

The consumer uses the mobile device to extract the unique validation token embedded within the QR code and transmits an extracted validation token from the mobile device back to the web server. The web server then compares the extracted validation token to the unique validation token to validate the electronic communications between the mobile device and the beverage dispenser. The web server verifies the authenticity of the token through a digital signature via, for example, HMAC hash-based message authentication code using a shared secret.

The graphical user interface at the mobile device transmits beverage commands, which in non-limiting embodiments, may include selecting a beverage available at the beverage dispenser, pouring the beverage from the beverage dispenser, and stopping the pouring of the beverage.

As used herein, and by example only, a beverage dispenser used in embodiments of this disclosure includes a beverage dispenser display connected to a computer processor and computerized memory storing beverage dispensing software, a nozzle configured to dispense a selected beverage, a plurality of pumping and/or metering devices, each configured to supply beverage ingredients for the selected beverage from an ingredient source to the nozzle according to commands executed in the beverage dispensing software, and a communications device configured to connect the beverage dispenser to a web server on a network and to receive beverage selection commands from the web server. The beverage dispenser, as noted above, includes encryption programs stored on the computerized memory of the beverage dispenser. The encryption programs are configured to create validation tokens for respective instances of beverage fulfillment, the validation tokens confirming authenticity of electronic communications and beverage selection commands from a mobile device. The encryption programs are further configured to incorporate the validation tokens into a QR code displayed on the beverage dispenser via a beverage dispenser display, wherein the beverage dispenser communicates the token and the QR code to the at least one server for use in the respective instance of beverage fulfillment.

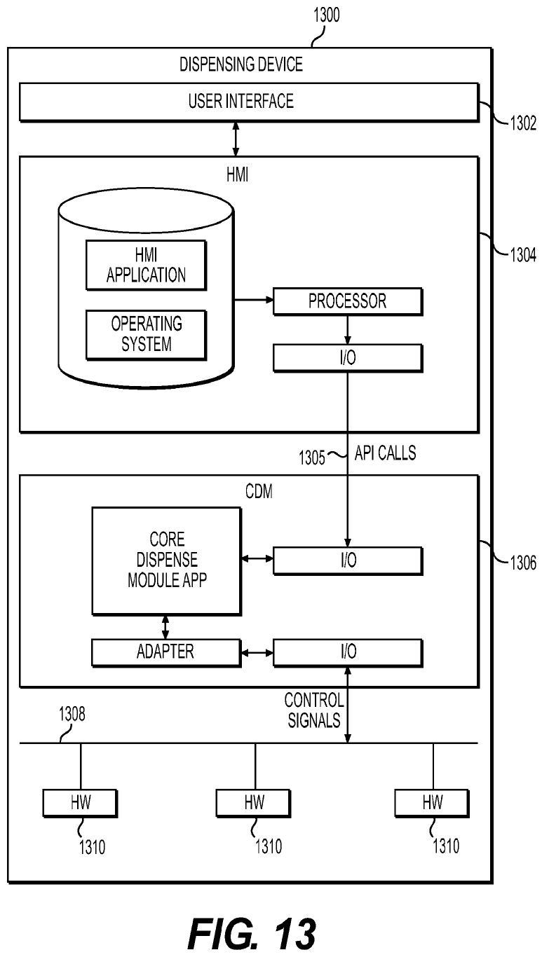

FIG. 13 illustrates an exemplary block diagram of a control architecture 1300 that may be used to control the beverage dispenser 1304 suitable for implementing the several embodiments of the disclosure. As shown in FIG. 13, control architecture 1300 may comprise a core dispense module (CDM) 1306, a human machine interface (HMI) module 1304, a user interface (UI) 1302, and a machine bus (MBUS) 1305. HMI 1304 may connect to or otherwise interface and communicate with at least one external device (e.g., mobile device 1352 or POS 1354) being external to beverage dispenser 1304. HMI 1304 may also control and update display screens on UI 1302. CDM 1306 may control flows from a plurality of pumps and/or valves 1310 in beverage dispenser 1304 according to a recipe to mix and dispense a product (e.g., a beverage) from beverage dispenser 1304.

Beverage ingredients (e.g., micro-ingredients, macro-ingredients, and/or diluents) may be combined to dispense various products that may include beverages or blended beverages (i.e., finished beverage products) from beverage dispenser 1304. However, beverage dispenser 1304 may also be configured to dispense beverage components individually.

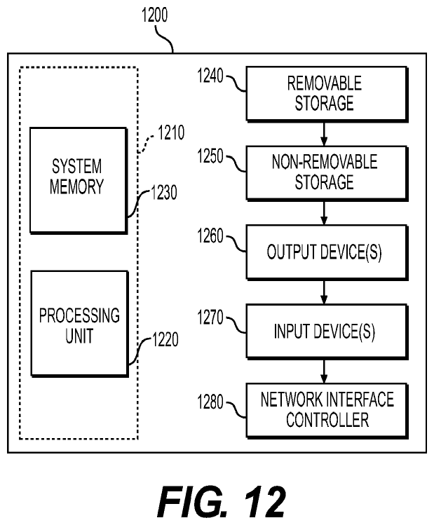

FIG. 12 illustrates an exemplary computer system 1200 suitable for implementing the several embodiments of the disclosure. For example, one or more components or controller components of the beverage dispenser may be implemented as the computer system 1200. In some implementations, one or both of the HMI 1304 and the CDM 1306 may be implemented as the computer system 1600.

It should be appreciated that the logical operations described herein with respect to the various figures may be implemented (1) as a sequence of computer implemented acts or program modules (i.e., software) running on a computing device (e.g., the computing device described in FIG. 12), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts, and modules may be implemented in software, in firmware, in special purpose digital logic, and any combination thereof. It should also be appreciated that more or fewer operations may be performed than shown in the figures and described herein. These operations may also be performed in a different order than those described herein.

Optionally, the computing device 1200 can be a well-known computing system including, but not limited to, personal computer, servers, handheld or laptop devices, multiprocessor systems, microprocessor-based systems, network personal computer (PCs), minicomputer, mainframe computer, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In some embodiments, the computing device 1200 may comprise two or more computer in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computer. In some embodiments, virtualization software may be employed by the computing device 1600 to provide the functionality of a number of servers that is not directly bound to the number of computer in the computing device 1200. For example, virtualization software may provide twenty virtual servers on four physical computer. In some embodiments, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In its most basic configuration, computing device 1200 typically includes at least one processing unit 1220 and system memory 1230. Depending on the exact configuration and type of computing device, system memory 1230 may be volatile (such as random access memory (RAM)), non-volatile (such as read-only memory (ROM), flash memory, etc.), or some combination of the two. This most basic configuration is illustrated in FIG. 12 by dashed line 1210. The processing unit 1220 may be a standard programmable processor that performs arithmetic and logic operations necessary for operation of the computing device 1200. While only one processing unit 1220 is shown, multiple processors may be present. Thus, while instructions may be discussed as executed by a processor, the instructions may be executed simultaneously, serially, or otherwise executed by one or multiple processors. The computing device 1200 may also include a bus or other communication mechanism for communicating information among various components of the computing device 1600.

Computing device 1200 may have additional features/functionality. For example, computing device 1200 may include additional storage such as removable storage 1240 and non-removable storage 1250 including, but not limited to, magnetic or optical disks or tapes. Computing device 1200 may also contain network connection(s) 1280 that allow the device to communicate with other devices such as over the communication pathways described herein. The network connection(s) 1280 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards such as code division multiple access (CDMA), global system for mobile communications (GSM), long-term evolution (LTE), worldwide interoperability for microwave access (WiMAX), and/or other air interface protocol radio transceiver cards, and other well-known network devices. Computing device 1200 may also have input device(s) 1270 such as a keyboard, keypads, switches, dials, mice, track balls, touch screens, voice recognizers, card readers, paper tape readers, or other well-known input devices. Output device(s) 1260 such as a printer, video monitors, liquid crystal displays (LCDs), touch screen displays, displays, speakers, etc. may also be included. The additional devices may be connected to the bus in order to facilitate communication of data among the components of the computing device 1200. All these devices are well known in the art and need not be discussed at length here.

The processing unit 1220 may be configured to execute program code encoded in tangible, computer-readable media. Tangible, computer-readable media refers to any media that is capable of providing data that causes the computing device 1200 (i.e., a machine) to operate in a particular fashion. Various computer-readable media may be utilized to provide instructions to the processing unit 1220 for execution. Example tangible, computer-readable media may include, but is not limited to, volatile media, non-volatile media, removable media, and non-removable media implemented in any method or technology for storage of information such as computer readable instructions, data structures, program modules or other data. System memory 1230, removable storage 1240, and non-removable storage 1250 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

It is fundamental to the electrical engineering and software engineering arts that functionality that can be implemented by loading executable software into a computer 610, 710 can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an application specific integrated circuit that hardwires the instructions of the software. In the same manner as a machine controlled by a new ASIC is a particular machine or apparatus, likewise a computer 610, 710 that has been programmed and/or loaded with executable instructions may be viewed as a particular machine or apparatus.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

1. A system for controlling a beverage dispenser to deliver a beverage from a nozzle, the system comprising:
a computer with memory connected to the beverage dispenser;
a wireless access point connected to the beverage dispenser and configured by the computer;
a beverage selection webpage hosted by the computer for wireless transmission within a range of the access point, wherein the computer is configured to receive beverage selection data from a remote rendering of the beverage selection website;
beverage selection data received at the computer from the remote rendering of the beverage selection website;
a valve assembly comprising an actuator in communication with the computer to configure the valve assembly actuator in an open position or a closed position, wherein the computer transmits control data to the actuator according to the beverage selection data, and
wherein, in the open position, the valve assembly actuator is operable to dispense a beverage fluid from a nozzle valve assembly.

2. The system of claim 1, further comprising at least one radio frequency (RF) transceiver in wireless communications with the computer and in data communication with the actuator, wherein the RF transceiver receives the control data from the computer and is configured to wirelessly transmit the to control data to the actuator according to the beverage selection data.

3. (canceled)

4. (canceled)

5. (canceled)

6. (canceled)

7. The system of claim 1, wherein the computer configures the access point with custom software corresponding to a mobile application used to communicate with the access point from a remote device.

8. (canceled)

9. The system of claim 1, further comprising signal connectors configured as respective direct wired connections connecting the actuator to the computer for data communication.

10. (canceled)

11. The system of claim 9, wherein the actuator is an electronic actuator in data communication with the computer, and the signal connectors extend from a general purpose input and output connections on a digital serial pin bus connected to the computer.

12. The system of claim 1, wherein the actuator is a dispenser lever solenoid valve.

13. The system of claim 1, wherein the access point is an intranet node providing communications infrastructure for the beverage dispenser and remote devices without an internet connection.

14. The system of claim 1, wherein the access point is a Wi-Fi connection to an establishment router that is separate from the computer and provides a connection to the internet for the computer and remote devices, and wherein the beverage dispenser serves the beverage selection webpage over the connection to the internet to the remote devices.

15. The system of claim 1, further comprising an external modem connected to the access point to deliver beverage transaction data to remote servers over the internet.

16. (canceled)

17. The system of claim 15, wherein the beverage transaction data comprises dispenser usage data, dispenser diagnostic data, beverage pour data, beverage volume data, dispenser location data, and/or remote device access data.

18. The system of claim 1, further comprising a display on the beverage dispenser displaying a first QR code comprising embedded data configured to initiate bidirectional wireless communications with the access point.

19. (canceled)

20. (canceled)

21. The system of claim 1, wherein the memory comprises computer coded instructions for transmitting, to an external computer in communication with the access point, beverage control buttons displayed on the remote rendering of the webpage and corresponding to the beverage selection data.

22. The system of claim 21, wherein at least one of the beverage control buttons is a pour button configured for establishing a feedback loop with the processor.

23. The system of claim 21, wherein at least one of the beverage control buttons is a pour button configured to initiate periodic pour commands from the computer to the actuator wherein the periodic pour commands are separated by a time interval and controlled by beverage selection data originating from the pour button.

24. (canceled)

25. The system of claim 21, wherein the computer uses the beverage selection data and the beverage dispensing software to dispense a selected beverage from the dispensing nozzles according to a flow control module stored in the memory.

26. (canceled)

27. A computer implemented method for controlling a beverage dispenser delivering a beverage to a nozzle, the method comprising:
hosting a beverage selection webpage in computerized memory connected to a computer installed in the beverage dispenser;
establishing an access point to the webpage with the computer;
receiving beverage selection data corresponding to the webpage at the access point and transmitting the beverage selection data to the computer; and
transmitting control data, configured according to the beverage selection data, to an actuator to open and close a valve that distributes the beverage to the nozzle.

28. The computer implemented method of claim 27, further comprising initiating communications at the access point with a first QR code.

29. The computer implemented method of claim 27, further comprising configuring the webpage to receive beverage selection data from an external computer in communication with the access point.

30. The computer implemented method of claim 27, further comprising controlling the actuator with communications transmitted from the access point to a respective RF transceiver connected to the actuator.

31. The computer implemented method of claim 27, further comprising controlling the actuator with communications transmitted across a signal connector extending from a digital serial pin bus on the computer to the actuator.
